(19) United States
(12) Patent Application Publication
(10) Pub. No.: US 2019/0360870 A1
(43) Pub. Date: Nov. 28, 2019

(54) DEVICE AND METHOD FOR SENSING ENVIRONMENTAL PARAMETERS OF STORAGE SYSTEM

(71) Applicant: FINETEK Co., Ltd., New Taipei City (TW)

(72) Inventors: Ting-Kuo WU, New Taipei City (TW); Jen-Shun WANG, New Taipei City (TW); Jia-Yi CHEN, New Taipei City (TW); Chien-Lung HUANG, New Taipei City (TW)

(21) Appl. No.: 15/987,890

(22) Filed: May 23, 2018

(51) Int. Cl. G01K 1/08; G01K 13/00; G01K 1/14; G01K 1/20

(52) U.S. Cl. CPC G01K 1/08; G01K 1/20; G01K 1/14; G01K 13/00

(57) ABSTRACT

A device and method for sensing environmental parameters of storage system is provided. A control unit and a temperature sensor are disposed in a sensor body. The temperature sensor and the capacitor electrode module are electrically connected with the control unit. The temperature sensor measures temperatures of the bulk solids and transmits the temperatures to the control unit.

The capacitor electrode module measures capacitances of the bulk solids and transmits the capacitances to the control unit. The control unit gets a moisture content through variations of capacitance signals, and an ambient humidity is calculated through the moisture content and temperature signals.

### BACKGROUND OF THE INVENTION

### Field of the Invention

The present invention generally relates to a level sensing device and, in particular to a multi-functional level sensing device.

### Description of Prior Art

In large storage systems, raw materials often have different moisture contents on account of environmental factors such as temperatures or humidity; thus, instable processes will be occurred owing to variations in moisture contents when raw materials are stored in the factory. Therefore, that will lead to a reworking and a longer process time and cause material waste and so on. Furthermore, common bulk solids such as cement, sand, feed, grain, iron sand, coal powder, tobacco, food, or chemical fiber products, etc. are presented in ways of lumps, granules, flakes, or powder due to the problem of moisture content. As a result, the moisture content will, in a minor case, make raw materials placed in the storage tank deteriorated, and, in a serious condition, causes safety incidents in workplaces.

A traditional method of sensing environmental factors is to install several single-function sensors for measuring temperatures, humidity, and moisture content separately. In addition, the above-mentioned sensing operations are carried out by disposing openings in part of the storage tanks despite the arrangement of these openings will result in inconvenience in use and maintenance of storage. Especially in the measurement of humidity, most of conventional hygrometers need openings for ventilation. However, for bulk solids, the openings for ventilation will be obstructed by the materials so that measurements cannot be performed, and a regular cleaning of maintenance is needed. Besides, the design of openings for ventilation cannot be applied in hazardous areas according to IEC 60079 related with explosion-proof certification regulations; thus that results in inconvenience in use.

In view of the above drawbacks, the Inventor proposes the present invention based on his expert knowledge and elaborate researches in order to solve the problems of prior art.

### SUMMARY OF THE INVENTION

Accordingly, an object of the present invention is to provide a device and method for sensing environmental parameters of storage system to measure environmental parameters such as temperatures, a moisture content, and a humidity of the storage system so that integration and multi-function sensing can be achieved.

In order to achieve the object mentioned above, the present invention provides a device for sensing environmental parameters of storage system for sensing bulk solids in a storage tank, comprising a sensor body, a control unit, a temperature sensor, and a capacitor electrode module. The sensor body is a closed structure and has an accommodating space. The control unit is disposed in the accommodating space. The temperature sensor is disposed in the sensor body and electrically connected with the control unit. The temperature sensor obtains temperature signals by measuring temperatures of the bulk solids through thermal sensing, and the temperature signals are transmitted to the control unit. The capacitor electrode module is combined with the sensor body and electrically connected with the temperature sensor. The capacitor electrode module measures capacitances of the bulk solids and obtains capacitance signals, and the capacitance signals are transmitted to the control unit, wherein the control unit gets a moisture content through variations of the capacitance signals, and an ambient humidity of the storage tank is calculated through the moisture content and the temperature signals.

In order to achieve the object mentioned above, the present invention provides a method for sensing environmental parameters of storage system including: providing a device for sensing environmental parameters of storage system; and the control unit calculating an ambient humidity of the storage tank through a conversion equation, a signal of the moisture content and the temperature signal.

Comparing to the prior art, the device for sensing environmental parameters of storage system provides a control unit, a temperature sensor and a capacitor electrode module in a closed sensor body, in which a moisture content is obtained by using the temperature sensor and the capacitor electrode module for measuring variations of the temperature signals and capacitance signals; and then an ambient humidity can be calculated by the control unit through a conversion equation, the moisture content, and the temperature signals. Therefore, the environmental parameters such as temperatures, the moisture content, and the ambient humidity of the storage system can be measured by a signal device so that integration and multi-function sensing can be achieved to enhance the convenience and practicality of the present invention.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a plan schematic view of the device for sensing environmental parameters of storage system of the present invention;

FIG. 2 is a plan schematic view of the capacitor electrode module of the present invention;

FIG. 3 is another plan schematic view of the device for sensing environmental parameters of storage system of the present invention.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

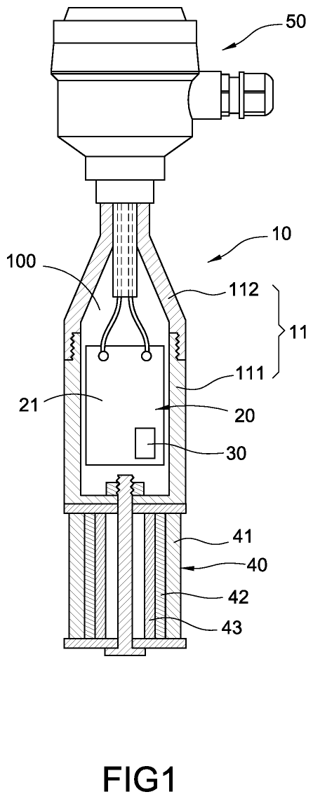

Please refer to FIG. 1, which depicts a plan schematic view of the device for sensing environmental parameters of storage system of the present invention. The present invention provides a device for sensing environmental parameters of storage system for sensing bulk solids in a storage tank including a sensor body 10, a control unit 20, a temperature sensor 30, and a capacitor electrode module 40. The temperature sensor 30 is used to measure temperatures of the bulk solids and disposed in the sensor body 10 with the control unit 20. The capacitor electrode module 40 is connected with the sensor body 10 for measuring capacitances of bulk solids for obtaining a moisture (water) content. More detailed descriptions of the device for sensing environmental parameters of storage system are as follows.

The sensor body 10 is a closed structure and has an accommodating space 100. In the present embodiment, the sensor body 10 includes a sealed shell seat 11 having the accommodating space 100. Specifically, the sealed shell seat 11 includes a protection tube 111 and a metal connector 112 screwed with the protection tube 111.

The control unit 20 is disposed in the accommodating space 100 of the sealed shell seat 11. The control unit 20 is used for receiving the temperatures measured by the temperature sensor 30 and the capacitances measured by the capacitor electrode module 40 so that a moisture (water) content can be obtained through variations of the capacitances. Thereby, an ambient humidity is calculated by the control unit 20 through the temperatures and the moisture (water) content.

The temperature sensor 30 is disposed in the sensor body 10 and electrically connected with the control unit 20. The temperature sensor 30 obtains temperature signals by measuring temperatures of the bulk solids through thermal sensing, and the temperature signals are transmitted to the control unit 20. It is preferable that, the temperature sensor 30 is, but not limited to, a thermocouple, a resistance temperature sensor or a thermistor.

In the present embodiment, the control unit 20 includes a control circuit board 21, and the temperature sensor 30 is disposed on the control circuit board 21. However, in an actual implementation, the position of the temperature sensor 30 can be adjusted according to the conditions of implementation.

Moreover, the capacitor electrode module 40 is combined with the sensor body 10 and electrically connected with the control unit 20. The capacitor electrode module 40 measures capacitances of the bulk solids and obtains capacitance signals, and then the capacitance signals are transmitted to the control unit 20. The control unit 20 gets a moisture content through variations of the capacitance signal, and an ambient humidity of the storage tank is calculated through the moisture content and the temperature signals. Specifically, the ambient humidity herein refers to a humidity of material surface in stable phase, and that will be referred to as the ambient humidity hereafter.

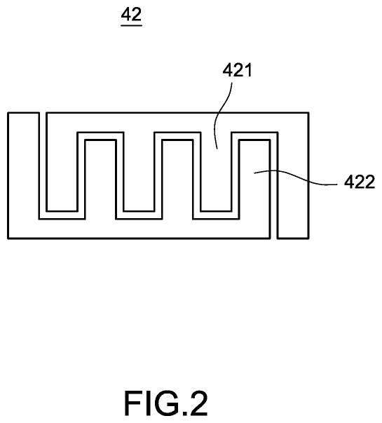

In the present embodiment, the capacitor electrode module 40 includes a protection shell 41, an electrode group 42 and an insulation supporter 43. The electrode group 42 are disposed between the protection shell 41 and the insulation supporter 43. In addition, please refer to FIG. 2, it depicts a plan schematic view of the electrode group 42 of the present invention. Preferably, the electrode group 42 include a first electrode unit 421 and a second electrode unit 422. The first electrode unit 421 and the second electrode unit 422 are opposite to each other and arranged in a crisscross isolated arrangement without electrically connecting with each other. In an actual implementation, the electrode group 42 are, but not limited to, copper foil substrates or flexible substrates (FPC) etc.

In more detail, the sensor body 10 of the present invention has a closed structure so that it does not have openings for disposing the temperature sensor 30. The measurement of the ambient humidity of the bulk solids by the device for sensing environmental parameters of storage system is performed without providing openings. In this way, the device can be avoided from inaccurate measurements in which openings are blocked by the materials.

It is worth noticing that in the method for sensing environmental parameters of storage system, the ambient humidity of the storage tank is calculated by the control unit 20 through a conversion equation, the moisture content and the temperature signals. Furthermore, the conversion equation can be an equilibrium water equation (ERH empirical model, Henderson empirical model, Chung-Pfost empirical model, Owsin empirical model, Halsey empirical model, or GAB (Guggenheim-Anderson-deBoer) empirical model) derived via Isotherm Equation. However, the calculation of the ambient humidity is not the focus of the application of the present invention and will not be described in detail herein.

In an embodiment of the present invention, the device for sensing environmental parameters of storage system further includes a holding box 50 connected at a side of the sensor body 10. Components such as electronic and circuit devices are disposed in the holding box 50 to integrate with the device 1 for sensing the environmental parameters of the storage system as an integral unit in order to facilitate the measurement operations for users.

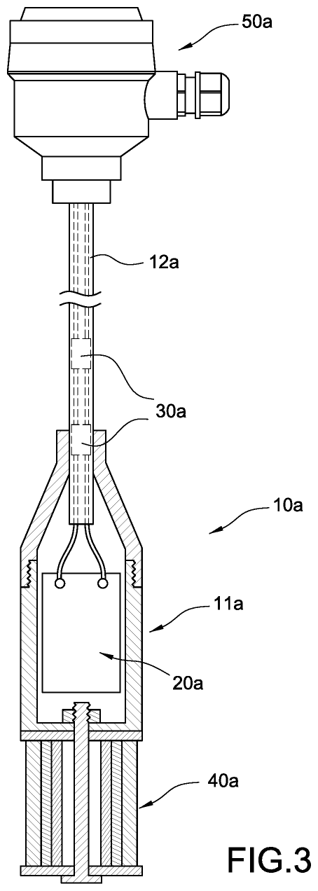

Please refer to FIG. 3, which depicts another plan schematic view of the device for sensing environmental parameters of storage system according to the present invention. The present embodiment is substantially the same as the previous embodiment. A device la for sensing environmental parameters of storage system includes a sensor body 10a, a control unit 20a, a temperature sensor 30a, a capacitor electrode module 40a, and a holding box 50a.

The difference between the present embodiment and the previous embodiment is that the sensing body 10a includes a sealed shell seat 11a and a flexible connecting element 12a. Furthermore, one end of the flexible connecting element 12a is connected with the holding box 50a and the other end is connected with the sealed shell seat 11a. Preferably, the flexible connecting element 12a is a high-tension cable.

In addition, another difference is that the temperature sensor 30a is disposed in the flexible connecting element 12a. Moreover, the measurement of the temperatures, the moisture content, and the calculation of the ambient humidity are the same as that in the previous embodiment and are not described again.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A device for sensing environmental parameters of storage system for sensing bulk solids in a storage tank, comprising:
a sensor body (10) being a closed structure, and the sensor body (10) having an accommodating space (100);
a control unit (20) disposed in the accommodating space (100);
a temperature sensor (30) disposed in the sensor body (10) and electrically connected with the control unit (20); the temperature sensor (30) obtaining temperature signals by measuring temperatures of the bulk solids through thermal sensing, and the temperature signals being transmitted to the control unit (20); and
a capacitor electrode module (40) combined with the sensor body (10) and electrically connected with the control unit (20); the capacitor electrode module (40) measuring capacitances of the bulk solids and obtaining capacitance signals, and the capacitance signals being transmitted to the control unit (20);
wherein the control unit (20) gets a moisture content through variations of the capacitance signals, and an ambient humidity of the storage tank is calculated through the moisture content and the temperature signals.

2. The device for sensing environmental parameters of storage system according to claim 1, wherein the capacitor electrode module (40) includes a protection shell (41), an electrode group (42) and an insulation supporter (43); the electrode group (42) is disposed between the protection shell (41) and the insulation supporter (43).

3. The device for sensing environmental parameters of storage system according to claim 2, wherein the electrode group (42) include a first electrode unit (421) and a second electrode unit (422); the first electrode unit (421) and the second electrode unit (422) are opposite to each other and arranged in a crisscross isolated arrangement.

4. The device for sensing environmental parameters of storage system according to claim 1, wherein the sensor body (10) includes a sealed shell seat (11) having the accommodating space (100).

5. The device for sensing environmental parameters of storage system according to claim 4, further including a holding box (50), wherein the sensor body (10) is connected at a side of the holding box (50).

6. The device for sensing environmental parameters of storage system according to claim 5, wherein the sensor body (10a) further includes a flexible connecting element (12a); one end of the flexible connecting element (12a) is connected with the holding box (50) and the other end is connected with the sealed shell seat (11).

7. The device for sensing environmental parameters of storage system according to claim 6, wherein the temperature sensor (30) is disposed in the flexible connecting element (12a).

8. The device for sensing environmental parameters of storage system according to claim 6, wherein the flexible connecting element (12a) is a cable.

9. The device for sensing environmental parameters of storage system according to claim 1, wherein the control unit (20) includes a control circuit board (21), and the temperature sensor (30) is disposed on the control circuit board (21).

10. A method utilizing a device for sensing environmental parameters of storage system according to claim 1, wherein an ambient humidity of the storage tank is calculated by the control unit (20) through a conversion equation, the moisture content, and the temperature signals.

11. The method for sensing environmental parameters of storage system according to claim 10, wherein the capacitor electrode module (40) includes a protection shell (41), an electrode group (42) and an insulation supporter (43); the electrode group (42) are disposed between the protection shell (41) and the insulation supporter (43).

12. The method for sensing environmental parameters of storage system according to claim 11, wherein the electrode group (42) includes a first electrode unit (421) and a second electrode unit (422); the first electrode unit (421) and the second electrode unit (422) are opposite to each other and arranged in a comb-like arrangement.

13. The method for sensing environmental parameters of storage system according to claim 10, wherein the sensor body (10) includes a sealed shell seat (11) having the accommodating space (100).

14. The method for sensing environmental parameters of storage system according to claim 13, further including a holding box (50), wherein the sensor body (10) is connected at a side of the holding box (50).

15. The method for sensing environmental parameters of storage system according to claim 14, wherein the sensor body (10a) further includes a flexible connecting element (12a); one end of the flexible connecting element (12a) is connected with the holding box (50) and the other end is connected with the sealed shell seat (11).

16. The method for sensing environmental parameters of storage system according to claim 15, wherein the temperature sensor (30) is disposed in the flexible connecting element (12a).

17. The method for sensing environmental parameters of storage system according to claim 15, wherein the flexible connecting element (12a) is a cable.

18. The method for sensing environmental parameters of storage system according to claim 10, wherein the control unit (20) includes a control circuit board (21), and the temperature sensor (30) is disposed on the control circuit board (21).
